(19) United States
(12) Patent Application Publication
(10) Pub. No.: US 2010/0081484 A1
(43) Pub. Date: Apr. 1, 2010

(54) COMMUNICATION APPARATUS, SEMICONDUCTOR INTEGRATED CIRCUIT, AND ELECTRONIC DEVICE

(76) Inventors: Hisateru Kobatake, Osaka (JP); Haruka Takano, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/444,775

(22) PCT Filed: Mar. 6, 2007
(86) PCT No.: PCT/JP2007/054272

§ 371 Date: Apr. 8, 2009

(30) Foreign Application Priority Data
Oct. 12, 2006 (JP) 2006 279096

(51) Int. Cl. H04B 7/005; H04L 7/00; H04M 1/00

(52) U.S. Cl. 455/574; 375/371; 455/522

(57) ABSTRACT

A communication apparatus (1) is provided with: a calculating unit (2) operable to calculate a correlation value of a predetermined pattern included in a receiving signal; a generating unit (3) operable to generate a synchronization signal according to the correlation value; a measuring unit (4) operable to measure a predetermined cycle according to the synchronization signal; and a control unit (5) operable to control power consumption of at least one of the calculating unit (2) and the generating unit (3). The measuring unit (4) includes the synchronization signal internally on a time axis, and defines a first period having a predetermined length and a second period not overlapping with the first period. The control unit (5) controls power consumption by operating an electronic signal in at least one of the calculating unit (2) and the generating unit (3) in the second period.

### TECHNICAL FIELD

The present invention relates to a communication apparatus, a semiconductor integrated circuit, and an electronic device, which are operable to perform decoding of a receiving signal, after a synchronization signal has been generated in response to the receiving signal.

### BACKGROUND ART

In reception of radio signals, it is necessary to generate a synchronization signal from the predetermined pattern included in the receiving signal (hereinafter, it is called as “synchronized detection”). In the synchronized detection, correlation calculating, by such as correlation using the predetermined pattern included in the receiving signal and autocorrelation between the received receiving signal and the delayed signal, is often used. The delayed signal is the received receiving signal which is delayed in terms of time.

In the correlation calculating, a lot of calculation, such as matched filter processes and inner product calculation, is necessary. In the calculation, many memory elements (for example, a flip flop, a latch, etc.) are also necessary. For this reason, synchronized detection requires a lot of power consumption.

The technology, which is reducing the quality of processing of a receiving circuit included in a communication apparatus when the state of the synchronized detection becomes worse, or stopping the clock signal to the receiving circuit, is proposed in order to reduce the power consumption in such synchronized detection. (For example, See Document 1 (Japanese Patent Application laid-open on No. 2003-37577)).

However, the technology disclosed in Document 1 reduces the power consumption only when the state of the synchronized detection became worse (in other words, a receiving state is bad), thus, this is not sufficient when considering the reduction of the power consumption.

If the clock signal is stopped when the receiving state becomes worse, afterwards, the synchronized detection and the receiving operation can not be performed unless the clock signal is returned. In order to resume the receiving operation, the clock signal needs to be returned. Although the receiving state needs to be good for returning the clock signal, since the clock signal is stopped, it is impossible to detect the change of the receiving state. In order to avoid this situation, the clock signal needs to be returned at an appropriate interval. Therefore, the conventional technology was not enough in order to satisfy both of the reduction of power consumption and receiving processing. In addition, since the load of processing in order to perform return processing of the clock signal is large, the reduction of power consumption is not enough.

### [Document 1]

Japanese Patent Application laid-open on No. 2003-37577

### DISCLOSURE OF INVENTION

### Problem(s) to be Solved by Invention

An object of the present invention is to provide a communication apparatus, a semiconductor integrated circuit, and an electronic device, which are operable to reduce power consumption without requiring the load of processing related to returning the clock signal, affecting the quality of synchronized detection, and stopping receiving operation.

### Means for Solving Problem(s)

A first aspect of the present invention provides a communication apparatus comprising: a calculating unit operable to calculate a correlation value of a predetermined pattern included in a receiving signal; a generating unit operable to generate a synchronization signal based on the correlation value; a measuring unit operable to measure a predetermined cycle based on the synchronization signal; and a control unit operable to control power consumption of at least one of the calculating unit and the generating unit, wherein the measuring unit defines a first period possessing a predetermined length and a second period not overlapping with the first period, the first period includes the synchronization signal on time axis, and the control unit operates an electric signal of at least one of the calculating unit and the generating unit in the second period, thereby controlling the power consumption.

According to the above configuration, the communication apparatus can reduce power consumption in term which calculation of synchronized detection is not necessary. In addition, the communication apparatus can keep synchronized detection while performing receiving operation. As a result, the communication apparatus enables both of performing receiving operation and reducing power consumption.

A second aspect of the present invention provides a communication apparatus, wherein the electric signal includes a supply clock signal supplied for at least one of the calculating unit and the generating unit, and the control unit reduces frequency of the supply clock signal in the second period, thereby controlling the power consumption.

According to the above configuration, the communication apparatus can reduce power consumption in term which calculation of synchronized detection is not necessary.

A third aspect of the present invention provides a communication apparatus, wherein at least one of the calculating unit and the generating unit comprises a memory element, the electric signal includes a held signal held by the memory element, and the control unit causes the held signal possess a specific value in the second period, thereby controlling the power consumption.

According to the above configuration, the communication apparatus can reduce power consumption in term which calculation of synchronized detection is not necessary.

A forth aspect of the present invention provides a communication apparatus, wherein the electric signal includes an enable signal supplied for the memory element, and the control unit keeps the enable signal in an ineffective status in the second period, thereby controlling power consumption.

According to the above configuration, the communication apparatus can reduce power consumption in term which calculation of synchronized detection is not necessary.

A fifth aspect of the present invention provides a communication apparatus, wherein the memory element includes a flip flop circuit.

According to the above configuration, the communication apparatus can reduce power consumption of the flip-flop circuit.

A sixth aspect of the present invention provides a communication apparatus, wherein the measuring unit adjusts the predetermined length of the first period based on the correlation value.

According to the above configuration, the communication apparatus can adjust term for reducing power consumption according to a reception status.

A seventh aspect of the present invention provides a communication apparatus further comprising: a cycle deviation calculating unit operable to calculate a cycle deviation of a synchronized cycle, the synchronized cycle being defined as a time interval between the synchronization signal and a synchronization signal adjacent to the synchronization signal on time axis, wherein the measuring unit adjusts the predetermined length of the first period based on the cycle deviation.

According to the above configuration, the communication apparatus can adjust term for reducing power consumption according to a reception status.

An eighth aspect of the present invention provides a communication apparatus further comprising: a judging unit operable to judge signal quality of the receiving signal, thereby outputting a judgment result, wherein the measuring unit adjusts the predetermined length of the first period based on the judgment result.

According to the above configuration, the communication apparatus can adjust term for reducing power consumption according to a reception status.

A ninth aspect of the present invention provides a communication apparatus, further comprising, a demodulating unit operable to demodulate the receiving signal, and a error detecting unit operable to detect an error based on an outputting signal by the demodulating unit, wherein the judging unit judges signal quality based on a result by the error detecting unit.

According to the above configuration, the communication apparatus can judge a reception status more certainly.

A tenth aspect of the present invention provides a communication further comprising: a pseudo synchronization signal generating unit operable to generate, based on the synchronization signal, a pseudo synchronization signal rising at every predetermined cycle; and a selecting unit operable to select either the synchronization signal or the pseudo synchronization signal, wherein the control unit operates an electric signal of at least one of the calculating unit and the generating unit in both of the first period and the second period, thereby controlling the power consumption when the pseudo synchronization is selected.

According to the above configuration, the communication apparatus can reduce more power consumption when a reception status is very favorable.

An eleventh aspect of the present invention provides a communication apparatus as defined in claim 10, wherein the electric signal includes a supply clock signal supplied for at least, one of the calculating unit and the generating unit, and the control unit reduces frequency of the supply clock signal in both of the first period and the second period, thereby controlling the power consumption, when the selecting unit selects the pseudo synchronization signal.

According to the above configuration, the communication apparatus can reduce more power consumption when a reception status is very favorable.

A twelfth aspect of the present invention provides a communication apparatus, wherein a synchronized cycle is defined as a time interval between synchronization signals adjacent to each other on time axis, a plurality of first periods are included in an N (N is a natural number.) number of synchronized cycles, each of which being the synchronized cycle, and the plurality of first periods including a specific first period, and the control unit returns the reduced frequency of the supply clock signal to former not reduced frequency in the specific first period among the plurality of first periods.

According to the above configuration, the communication apparatus can maintain accuracy of detecting the synchronization signal while reducing power consumption.

A thirteenth aspect of the present invention provides a communication apparatus, wherein the control unit operates the N number of the synchronized cycles based on a judgment result outputted from the judging unit.

According to the above configuration, the communication apparatus keeps balance between reducing power consumption and improving accuracy in detecting the synchronization signal in accordance with a reception status.

A fourteenth aspect of the present invention provides a communication apparatus, wherein at least one of the calculating unit and the generating unit comprises a memory element, the electric signal includes a held signal by the memory element, and the control unit causes the held signal possess a specific value in both of the first period and the second period when the selecting unit selects the pseudo synchronization signal.

According to the above configuration, the communication apparatus can perform further reduction of power consumption.

### EFFECT OF INVENTION

According to the present invention, it is possible to effectively reduce the unnecessary power consumption in the synchronized detection regardless of the state of reception. In addition, the accuracy of the synchronized detection is not affected.

Herein, the load of processing required for switching, such as a power reduction mode and a normal mode, is also unnecessary. Since the synchronized detection does not need to be stopped, return processing of the synchronized detection is not necessary.

### BRIEF DESCRIPTION OF DRAWINGS

FIG. 1 is a block diagram of a communication apparatus according to Embodiment 1 of the present invention;

FIG. 2 indicates explanation of signal processing based on a time axis according to Embodiment 1 of the present invention;

FIG. 3 is a timing chart indicating generation of a synchronization signal according to Embodiment 1 of the present invention;

FIG. 4 is a timing chart explaining processing using a pseudo synchronization signal according to Embodiment 2 of the present invention;

FIG. 5 is a timing chart explaining processing using a pseudo synchronization signal according to Embodiment 2 of the present invention; and

FIG. 6 a block diagram of a semiconductor integrated circuit according to the present invention.

### DESCRIPTION OF SYMBOLS

1 Communication apparatus
2 Calculating unit
3 Generating unit
4 Measuring unit
5 Control unit
6 Synchronization monitoring unit
7 Cycle deviation calculating unit
8 Pseudo synchronization signal generating unit
9 Selecting unit
10 Demodulating unit
11 Error detecting unit
12 Judging unit

### THE MODE FOR CARRYING OUT THE INVENTION

Next, referring to the attached drawings, Embodiments of the present invention will be now explained.

### Embodiment 1

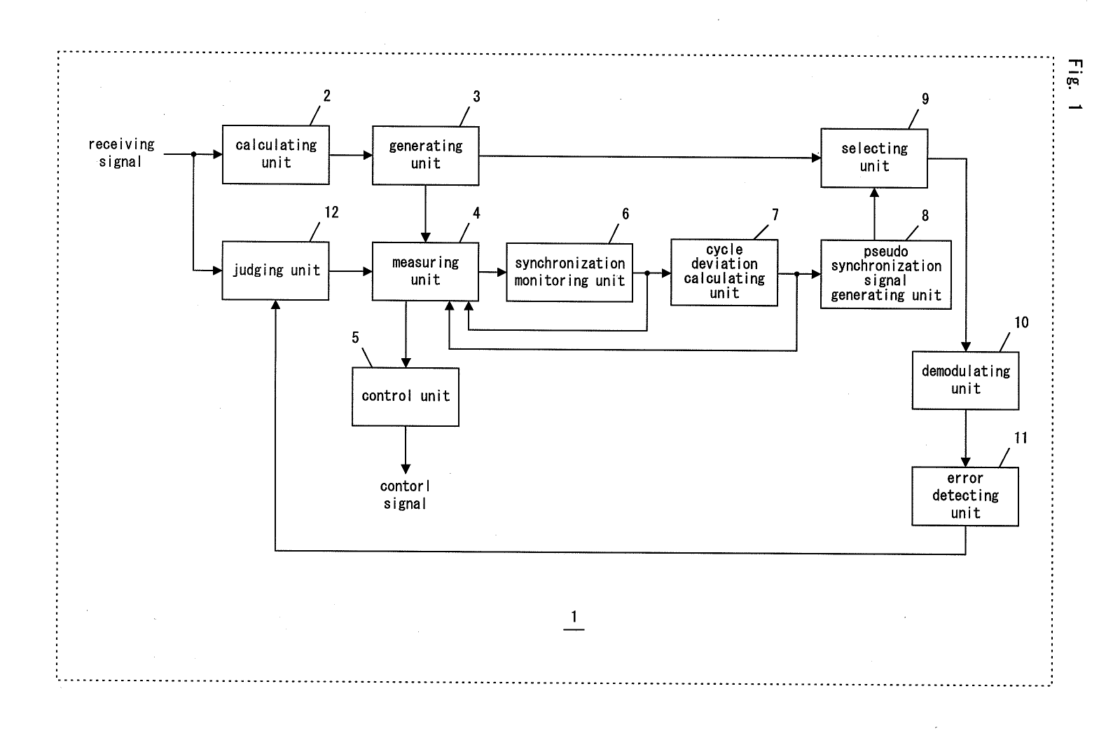

FIG. 1 is a block diagram of a communication apparatus according to Embodiment 1 of the present invention. In addition, each element shown in FIG. 1 is an element required for a communication apparatus of the present invention. Another element can be added if necessary.

(Entire Outline)

First, the entire outline will be explained.

A communication apparatus 1 is provided with: a calculating unit 2, a generating unit 3, a measuring unit 4, and a control unit 5. In addition to these, if necessary, the communication apparatus 1 is provided with: a synchronization monitoring unit 6, a cycle deviation calculating unit 7, a pseudo synchronization signal generating unit 8, a selecting unit 9, a demodulating unit 10, an error detecting unit 11, and a judging unit 12.

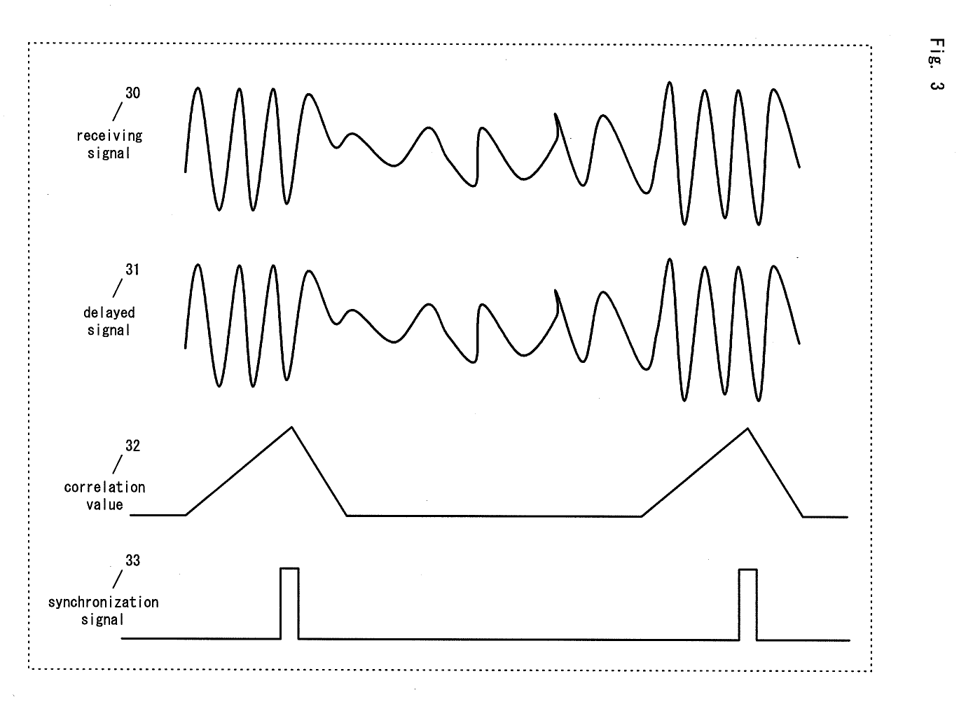

A receiving signal is inputted into the communication apparatus 1. This receiving signal may be an analog signal, and may be a digital signal that is converted by an analog-to-digital converter. In FIG. 3, which explains synchronized detection in the following, the receiving signal is explained as an analog signal.

The calculating unit 2 calculates a correlation value of the predetermined pattern included in the receiving signal. The generating unit 3 generates a synchronization signal which shows a border of a receiving signal according to the correlation value. This synchronization signal is used as a border of processing when the receiving signal is demodulated.

A measuring unit 4 measures a predetermined interval according to the synchronization signal, and a time interval between the synchronization signals, which are next to each other on time axis (hereinafter it is called a “synchronized cycle”). Furthermore, the measuring unit 4 defines a first period and a second period according to the synchronization signal.

The information of the first period and the second period defined by the measuring unit 4 is outputted to the control unit 5.

In the second period, the control unit 5 operates the electronic signal of at least one of the calculating unit 2 and the generating unit 3. The electronic signal to be controlled is at least one of a supply clock signal to the calculating unit 2 and the generating unit 3, a held signal of a memory element included in the calculating unit 2 and the generating unit 3, and an enable signal. Since these electronic signals are operated, it is possible to control the power consumption in the calculating unit 2 and the generating unit 3. In other words, it is possible to reduce the power consumption.

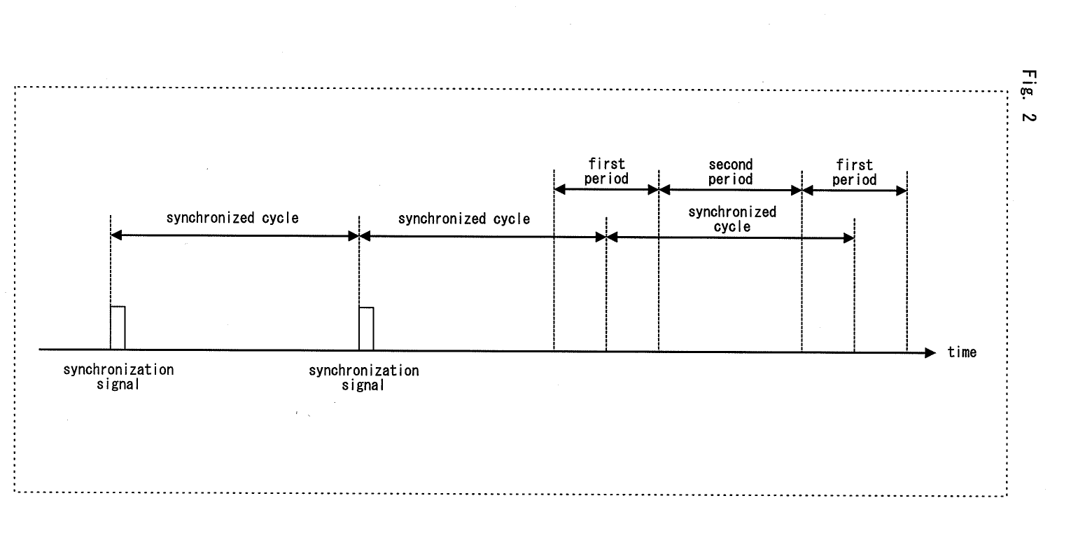

Referring to FIG. 2, the operation of an electronic signal will be now explained. FIG. 2 indicates explanation of signal processing based on a time axis according to Embodiment 1 of the present invention.

In FIG. 2, according to the synchronization signal generated by the generating unit 3, the state, where the first period and the second period are defined, is shown. The first period is a period that possesses the predetermined length including the synchronization signal exists in a certain time on the time axis inside. In other words, on the time axis, the period includes start timing and end timing of a certain synchronization signal. In addition, although a plurality of synchronization signals exists on the time axis, a first period is defined in each synchronization signal.

The second period is a period that does not overlap the first period. In other words, the first period and the second period exist, without overlapping each other.

The first period is a period that performs the synchronized detection including calculation of a correlation value, or generation of a synchronization signal. The second period is a period which does not need the synchronized detection.

In the second period that does not need such synchronized detection, the control unit 5 reduces frequency of a clock signal or fixes a held signal of a memory element to a specific value (preferably a value “0”). Thus, it is possible to reduce unnecessary power consumption.

As mentioned above, in the communication apparatus 1 according to Embodiment 1, even if it is in the state where the synchronized detection and decoding, which continues to the synchronized detection, are performed (regardless of the state of reception), it is possible to reduce the unnecessary power consumption. In addition, since the necessary calculation for the synchronized detection is not stopped while the control for reducing the power consumption is performed, the synchronized detection and the decoding of the receiving signal, which continues to the synchronized detection, are performed continuously without trouble.

For this reason, the load of processing required for switching, such as a power reduction mode and a normal mode, is also unnecessary. Moreover, it is possible to reduce the power consumption.

Next, the details of each unit and details of operation will be now explained.

(Calculating Unit)

The calculating unit 2 calculates a correlation value of a predetermined pattern included in a receiving signal. If the predetermined pattern is already known at this time, the calculating unit 2 calculates the correlation value by performing calculation of convolution for the receiving signal and the known pattern (correlation). Alternatively, as shown in FIG. 3, the calculating unit 2 calculates the correlation value by making the receiving signal delayed for certain time, and performing the calculation of convolution of the receiving signal and the delayed receiving signal (autocorrelation).

The calculating unit 2 outputs an operation result to the generating unit 3. The operation result to be outputted may include a signal shown by the result of the calculation of convolution, and a predetermined notifying signal that is obtained by quantizing the result of the calculation of convolution.

In addition, the calculation of convolution is an example. Thus, the correlation value may be calculated by comparing the value with the known pattern.

(Generating Unit)

The generating unit 3 generates and outputs a synchronization signal according to the correlation value.

Specifically, a pulse signal is generated at the timing when the correlation value is becoming a peak value. The pulse signal is generated as the synchronization signal. Alternatively, the pulse signal is generated as the synchronization signal at the timing when the correlation value is larger than the predetermined value.

FIG. 3 is a timing chart indicating generation of a synchronization signal according to Embodiment 1 of the present invention. Referring to FIG. 3, synchronized detection of a receiving signal will be now explained. In addition, the synchronized detection shown in FIG. 3 is an example of the synchronized detection by autocorrelation. Thus, the method of the synchronized detection is not limited to this.

A receiving signal 30 is inputted into a calculating unit 2. At this time, the calculating unit 2 is provided with a memory. The receiving signal is delayed for the predetermined period. The delayed receiving signal is a delayed signal 31.

A receiving signal 30 and the delayed signal 31 are signals which include the same predetermined pattern. The predetermined pattern possesses correlativity (other than this, the predetermined pattern does not have correlativity).

When the calculation of convolution is performed for the receiving signal 30 and the delayed signal 31, a correlation value 32 will be obtained. The calculating unit 2 outputs the correlation value 32, which is a result of the calculation of convolution to the generating unit 3.

The generating unit 3 generates and outputs a synchronization signal 33 according to the correlation value 32. In FIG. 3, the peak part of the correlation value 32 is the generation timing of the synchronization signal 33.

By the above-mentioned processing, the generating unit 3 generates and outputs the synchronization signal 33.

In addition, the synchronization signal 33 may be generated at the timing when the correlation value 32 is larger than the predetermined value.

In FIG. 1, although the calculating unit 2 and the generating unit 3 are shown separately, they do not need to be distinguished with each other. As far as these functions are included in a circuit or a semiconductor integrated circuit, which realizes the communication apparatus 1 of the present invention, the calculating unit 2 and the generating unit 3 may be combined.

(Measuring Unit)

Next, the measuring unit 4 will be now explained.

The measuring unit 4 defines a first period and a second period according to a synchronization signal.

The first period and the second period are as shown in FIG. 2. The first period exists for every time when the synchronization signal exists. The second period exists in the period which does not overlap with the first period. The first period and the second period are defined by turns.

Each length of the first period and the second period is variable. The measuring unit 4 adjusts each length of the first period and the second period according to various kinds of conditions. For example, each length of the first period and the second period is adjusted according to the information from the calculating unit 2 or the judging unit 12.

In addition, periods are divided into the first period and the second period here. In short, during the receiving operation, since it is enough if the period, in which the unnecessary power consumption is reduced, is known, the first period and the second period may include periods that are subdivided.

Here, when the second period is longer than the first period, time assigned for calculation related to the synchronized detection is short.

When a receiving state is good, even if the first period is short, operation required for the synchronized detection is completed and a synchronization signal is generated appropriately. When the first period becomes shorter, the second period, which is not overlapped with the first period, becomes longer. Here, in the second period, since the power consumption in the calculating unit 2 and the generating unit 3 is controlled, the power consumption can be reduced more.

On the contrary, when the second period is short, the period, which is operable to perform the necessary calculation for the synchronized detection, is long. When the receiving state becomes worse and a waveform deteriorates, the synchronized detection needs a long operation period. For this reason, setting the first period longer and performing the synchronized detection appropriately have priority over increasing the reduction of the power consumption amount.

By making the first period fully secured, it is possible to generate the synchronization signal with high accuracy. Thus, the accuracy of subsequent recovery processing also becomes higher.

Next, adjustment of the length of the first period and the second period will be now explained.

The measuring unit 4 adjusts the length of the first period and the second period according to the operation result from the calculating unit 2.

(Adjustment of Length According to Correlation Value)

The correlation value calculated by the calculating unit 2 changes according to the receiving states. When the receiving state is good, since the result of calculation of convolution for the predetermined patterns is good, the correlation value has the large peak value. On the other hand, when the receiving state is bad, since the result of calculation of convolution for the predetermined patterns is bad, the correlation value has the small peak value. Thus, the correlation value or the peak value of the correlation value shows the quality of the receiving state. In response, the measuring unit 4 adjusts the length of the first period (as a result, as well as the second period) according to the correlation value or the peak value of the correlation value. For example, when the correlation value is larger than or equal to the predetermined value, the measuring unit 4 defines the first period shorter than the standard. When the correlation value is smaller than the predetermined value, the measuring unit 4 defines the first period longer than the standard. It is similar when the peak value of the correlation value is used.

(Adjustment of Length According to Cycle Deviation)

Moreover, the measuring unit 4 adjusts the length of the first period (the second period as a result) according to the cycle deviation calculated by the cycle deviation calculating unit 7. As mentioned later, the cycle deviation calculating unit 7 accumulates a value of a synchronized cycle, and calculates the deviation of the synchronized cycle (henceforth, it is called as “cycle deviation”). The calculated cycle deviation is outputted to the measuring unit 4. The measuring unit 4 adjusts the length of the first period according to the cycle deviation.

For example, when the cycle deviation is larger, it means the accuracy of the synchronized detection is bad (in other words, the receiving state is bad). Thus, the measuring unit 4 defines the first period, which is a period for performing the synchronized detection, longer (in other words, the second period is shortened). Thereby, it is possible to secure the accuracy of the synchronized detection in the bad receiving state.

On the other hand, when the cycle deviation is small, it means that the synchronized detection is good (in other words, the receiving state is good). Thus, the measuring unit 4 defines the length of the first period, which is a period for performing the synchronized detection, shorter (in other words, the second period, in which the power consumption is reduced, becomes longer).

(Adjustment of Length According to Signal Quality)

Moreover, according to the judgment result from the judging unit 12 mentioned later, the measuring unit 4 adjusts the length of the first period.

The judging unit 12 judges signal quality according to a receiving signal. Alternatively, the judging unit 12 judges the signal quality according to a result of the error detecting unit 11.

For example, the judging unit 12 judges the signal quality according to the voltage or electric power of the receiving signal. When the voltage or electric power of the receiving signal is larger than or equal to the predetermined value, the judging unit 12 judges that the receiving state is good.

The measuring unit 4 adjusts the length of the first period according to the judgment result. For example, when it is judged that the signal quality is bad in the judgment result, the measuring unit 4 defines the length of the first period, which is a period for performing the synchronized detection, longer (in other words, the second period is shortened). Hereby, even when the receiving state is bad, it is possible to secure the accuracy of the synchronized detection.

On the other hand, when the signal quality is good, since it means that the state of the synchronized detection is good (in other words, the receiving state is good), the measuring unit 4 defines the length of the first period, which is a period for performing the synchronized detection, shorter (in other words, the second period, in which the power consumption is reduced, becomes longer).

Moreover, according to a “bit error rate (henceforth, it is called as “BER”)” detected by the error detecting unit 11 or an S/N ratio, the judging unit 12 judges the signal quality and outputs the judgment result to the measuring unit 4.

The measuring unit 4 adjusts the length of the first period according to the judgment result. For example, when it is judged that the signal quality is bad in the judgment result, the length of the first period, which is a period for performing the synchronized detection, is defined longer (in other words, the second period is shortened). Thereby, even when the receiving state is bad, it is possible to secure the accuracy of the synchronized detection.

On the other hand, when the signal quality is good, since it means that the state of the synchronized detection is good (in other words, the receiving state is good), the measuring unit 4 defines the length of the first period, which is a period for performing the synchronized detection, shorter (in other words, the second period, in which the power consumption is reduced, becomes longer).

In addition, although the measuring unit 4 adjusts the length of the first period (and the second period) related to the quality of synchronized detection and the amount of reduction in power consumption according to the correlation value, the cycle deviation, and the signal quality, etc., in addition to the adjustment of two patterns, such as “long/short”, the length of the first period may be adjusted in analog, or maybe adjusted by variety of patterns according to the corresponding table or the corresponding equation between the reference value and the length.

As mentioned above, in the measuring unit 4, by adjusting the length of the first period and the second period according to the various references, it is possible to reduce the unnecessary power consumption at a maximum while eliminating the influence on the synchronized detection, which is the most basic in the reception processing.

In addition, the first period and the second period may be adjusted according to the predetermined period length, or may be adjusted according to the current period length.

(Control Unit)

Next, the control unit 5 will be explained.

The control unit 5 operates an electronic signal of at least one of the calculating unit 2 and the generating unit 3 in the second period. By the operation, in the second period, it is possible to reduce the power consumption of at least one of the calculating unit 2 and the generating unit 3 (since the calculation related to the synchronized detection is not necessary for the second period). As a result, it is possible to reduce the power consumption of the communication apparatus 1.

Here, the control unit 5 sets at least one of the supply clock signal to at least one of the calculating unit 2 and the generating unit 3, an held signal of the memory element included in at least one of the calculating unit 2 and the generating unit 3, and an enable signal supplied to the memory element as the electronic signal to be controlled.

By controlling these kinds of electronic signals, the control unit 5 controls (reduces) the power consumption of the calculating unit 2 and the generating unit 3 (and the communication apparatus 1 including these).

(Operation of Supply Clock Signal)

In the second period, the control unit 5 reduces the frequency of the supply clock signal to at least one of the calculating unit 2 and the generating unit 3. Here, the supply clock signal may be a clock signal supplied from the outside, or may be a clock signal generated inside. The supply clock signal includes a divided clock signal. In short, the clock signal, which is used for the digital circuit in the calculating unit 2 and the generating unit 3, is operated.

In addition, reducing the frequency of the supply clock signal includes stopping the supply clock signal.

Since the control unit 5 reduces the frequency of the supply clock signal, it is possible to reduce the unnecessary power consumptions in at least one of the calculating unit 2 and the generating unit 3 (in the second period, which does not require the synchronized detection).

(Operation of Memory Element)

Similarly, the control unit 5 fixes the held signal of the memory element included in at least one of the calculating unit 2 and the generating unit 3 to the specific value (preferably, a value “0”). The memory element widely includes, for example, a flip flop, a register, a memory, ROM, RAM and so on. Such a memory element is consisted of an MOS transistor, and when the held value is fixed to the value “0”, since the leakage current between the source drains of the MOS transistor, it is possible to reduce the power consumption.

In addition, the value “0” is a value “0” of the values between “1” and “0”, which are the 2 values of the digital values possessed by the memory element. The value “0” does not strictly mean a value “0” as a scalar value.

Moreover, the control unit 5 fixes the enable signal supplied to the memory element to an “ineffective status”. Since the enable signal of the memory element is fixed to the “ineffective status”, there is no change of the held signal for the memory element, and the switching current is reduced. Thus, it is possible to reduce the power consumption.

Especially, when the memory element includes the flip flop, since the enable signal to be inputted into the flip flop is fixed to the “ineffective status”, the value of the flip flop does not change. Thus, it is possible to reduce the switching current.

As mentioned above, since the control unit 5 operates the electronic signal, it is possible to reduce the unnecessary power consumption in the second period, and is possible to reduce the power consumption of the entire of the communication apparatus 1.

In addition, each of the supply clock signal, the held signal of the memory element, and the enable signal may be operated independently, and may be operated by a combination.

(Synchronization Monitoring Unit)

The synchronization monitoring unit 6 monitors a state of the synchronization according to the synchronized cycle calculated by the measuring unit 4.

A monitoring result is fed back to the measuring unit 4, and is used for the definition of the first period and the second period if necessary.

(Cycle Deviation Calculating Unit)

The cycle deviation calculating unit 7 accumulates the synchronized cycle cumulatively, and calculates the deviation as the above-mentioned. The cycle deviation calculating unit 7 outputs the calculated deviation to the measuring unit 4 as the cycle deviation. As mentioned above, the measuring unit 4 adjusts the length of the first period and the second period according to the cycle deviation.

In addition, the cycle deviation calculating unit 7 may calculate the difference between the maximum value and the minimum value of the accumulated synchronized cycle as the cycle deviation, may calculate the standard deviation as the cycle deviation, and may calculate the difference between the average value and the maximum value as the cycle deviation.

(Demodulating Unit)

The demodulating unit 10 demodulates by such as orthogonal demodulating, and demodulates digital data included in the receiving signal.

The demodulated result is outputted to the error detecting unit 11.

(Error Detecting Unit)

The error detecting unit 11 detects an error using a predetermined error detection method according to the demodulating result. For example, Vitarbi decoding, a cyclic redundancy check, etc. are used for detecting an error. As mentioned above, the judging unit 12 uses the detection result for judging the signal quality.

As mentioned above, by the communication apparatus 1 of Embodiment 1, without giving an influence on the accuracy of the synchronized detection, it is possible to reduce the power consumption regardless of the receiving state.

In addition, the communication apparatus 1 may be realized by the electronic circuit realizing these functions, and may be realized by a semiconductor integrated circuit. The part of the function, such as correlation calculating and synchronized detection, may be realized by a software. Regardless of how it is realized, it is possible to reduce the power consumption according to the above-mentioned processing.

When it is configured with the software, a ROM or a RAM storing a processor and a program is provided, and necessary processing there-with is performed.

A CPU reads the program stored in the ROM or RAM. Subsequently, the CPU receives a signal, and performs demodulating of the signal using the read program. At this time, the CPU performs the synchronized detection and the operation of the electronic signal according to the read program.

In addition, the pseudo synchronization signal generating unit 8 and selecting unit 9 shown in FIG. 1 will be explained in Embodiment 2.

### Embodiment 2

Next, Embodiment 2 of the present invention will be explained.

The communication apparatus in Embodiment 2 of the present invention is provided with the pseudo synchronization signal generating unit 8 and the selecting unit 9.

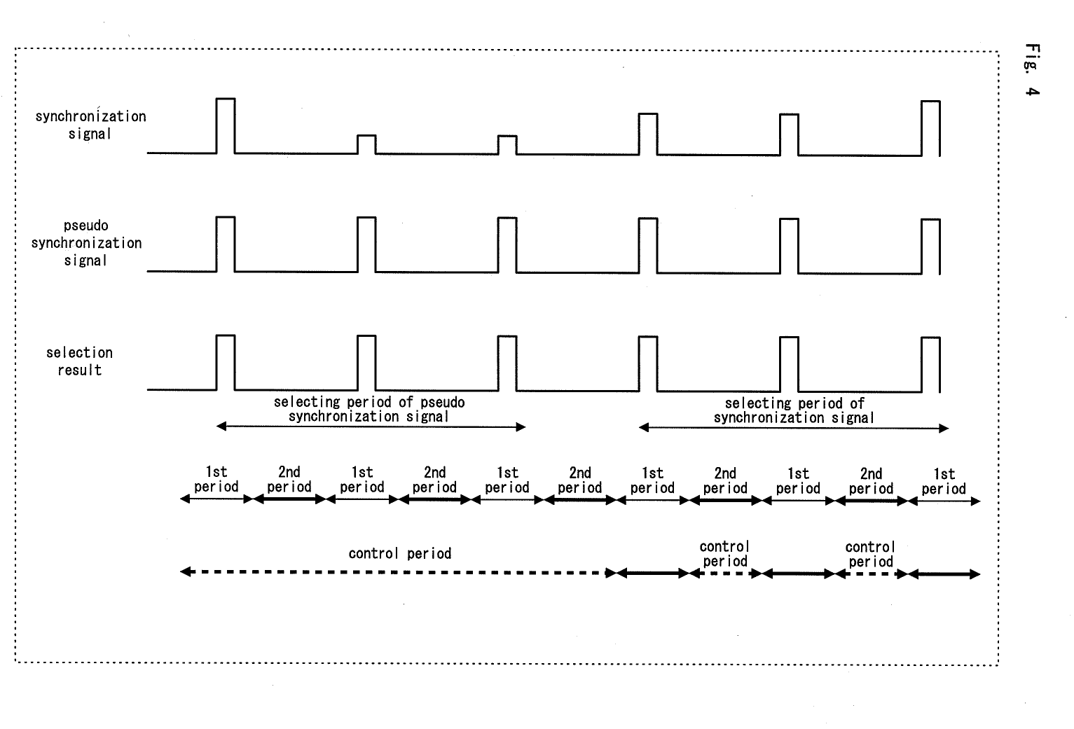

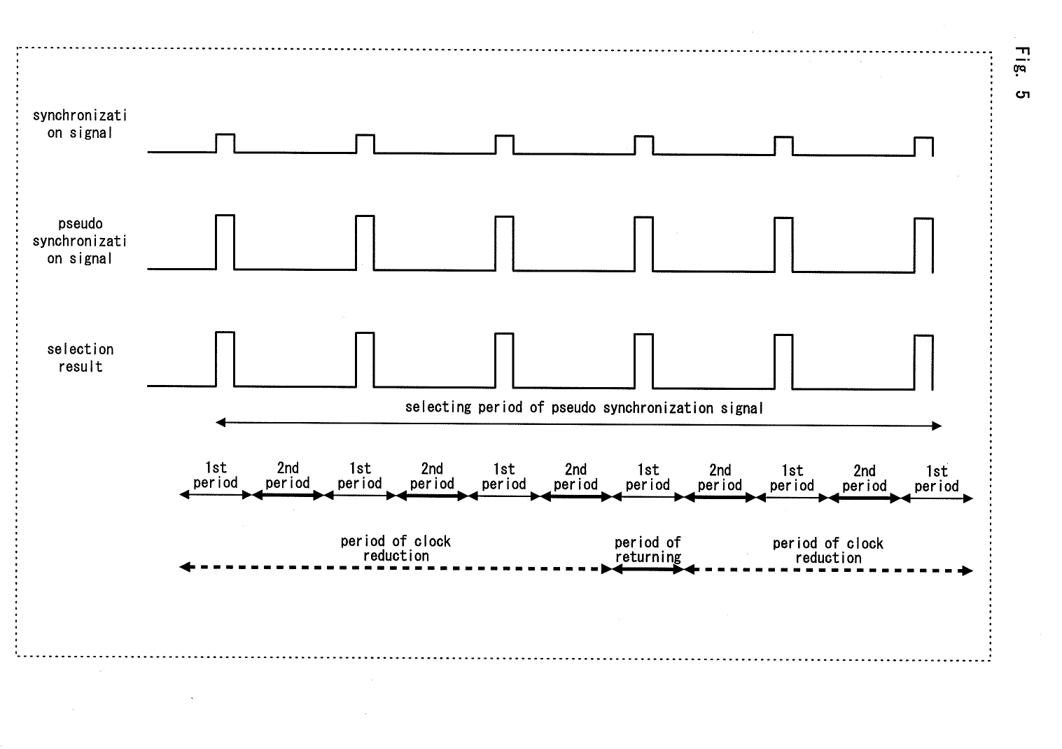

It will be explained, referring to FIG. 1, FIG. 4, and FIG. 5.

The pseudo synchronization signal generating unit 8 generates a pseudo synchronization signal according to the synchronization signal generated by the generating unit 3, and the synchronized cycle, which is measured by the measuring unit 4.

Unless both of the kind of receiving signal to be received and the receiving state do not change, the synchronization signal should be generated for every same interval (since degradation in waveform arises when the receiving state changes, if the synchronized detection is performed from the receiving signal, the synchronized cycle may change). For this reason, if the receiving state is good and the waveform variation does not occur, and a certain synchronization signal is generated by the generating unit 3, it is thought that the next synchronization signal may be generated for every synchronized cycle.

According to the thought, the pseudo synchronization signal generating unit 8 generates a pseudo synchronization signal one after another for every synchronized cycle measured by the measuring unit 4, according to the certain synchronization signal generated by the generating unit 3. In addition, the synchronized cycle may be calculated by the average value of the plurality of synchronized cycles.

The selecting unit 9 selects either the synchronization signal (synchronization signal generated using the receiving signal) generated by the generating unit 3, or the pseudo synchronization signal. When the receiving state is good, the selecting unit 9 selects the pseudo synchronization signal (since the receiving state is good, there is no problem that the pseudo synchronization signals generated at the same interval may be used for the following demodulating). On the contrary, when the receiving state is bad, the selecting unit 9 selects the synchronization signal from the generating unit 3.

Here, the selecting unit 9 judges whether the receiving state is good or bad using the judgment result in the judging unit 12.

Moreover, when the number of the generated synchronization signal is larger than the predetermined number, the selecting unit 9 judges that the receiving state is good, and selects the pseudo synchronization signal.

Thus, in the period when the selecting unit 9 selects the pseudo synchronization signal, it is not necessary to perform the synchronized detection from the receiving signal. For this reason, in the period when the pseudo synchronization signal is selected, not only in the second period, but also in the first period, the reduction of the power consumption should have priority.

When the pseudo synchronization signal is selected, the control unit 5 operates the electronic signal of at least one of the calculating unit 2 and the generating unit 3 in both of the first period and the second period. More specifically, similar to the explanation in Embodiment 1, the reduction of the supply clock (including stopping), the fixation of the held signal of the memory element, and the fixation of the enable signal to the memory element into the ineffective state, are performed.

FIG. 4 and FIG. 5 are timing charts explaining processing using a pseudo synchronization signal according to Embodiment 2 of the present invention

In the first half of a timing chart in terms of time, the selecting unit 9 selects the pseudo synchronization signal. In the period, operation by the control unit 5 is performed in both of the first period and the second period. As shown in FIG. 4, the selecting period of the pseudo synchronization signal is a control period in the first period, the second period, and also others. In the control period, the control unit 5 reduces the frequency of the supply clock signal to at least one of the calculating unit 2 and the generating unit 3. Alternatively, the control unit 5 fixes the held signal of the memory element included in at least one of the calculating unit 2 and the generating unit 3 to the value “0”. Alternatively, the control unit 5 fixes the enable signal to the memory element included in at least one of the calculating unit 2 and the generating unit 3 to the “ineffective status”.

According to the operation by the control unit 5, it is possible to reduce the unnecessary power consumption in the period when the pseudo synchronization signal is selected. This is because the pseudo synchronization signal is used as “synchronization signal”, in such as the demodulating unit 10, and the calculation in the calculating unit 2 and the generating unit 3 performing the calculation related to the synchronized detection is unnecessary. For this reason, although reduction of the power consumption improves, there is no influence on the receiving operation of the communication apparatus 1 at all.

On the contrary, as shown in the latter half of FIG. 4 in terms of time, in the period when the synchronization signal is selected, the control unit 5 operates the electronic signal only in the second period similar to Embodiment 1.

### Modification Example

Next, the modification example using the pseudo synchronization signal Embodiment 1 of the present invention will be explained.

The control unit 5 operates the electronic signal of at least one of the calculating unit 2 and the generating unit 3 in the period when the pseudo synchronization signal is selected. Especially, the control unit 5 reduces the frequency of the supply clock signal to at least one of the calculating unit 2 and the generating unit 3.

Here, even if it is while the pseudo synchronization signal is selected, since there may be a change of the receiving state, it may be preferable to acquire the synchronization signal from the receiving signal. In other words, even when it is while the pseudo synchronization signal is generated and selected, it is desirable that the generation of the pseudo synchronization signal is readjusted (refreshed).

In the selecting period of the pseudo synchronization signal, for the specific first period included in the period, the control unit 5 restores the frequency of the reduced clock signal.

If a period for N synchronized cycles (N is a natural number) is defined as N-th synchronized cycle, among the plurality of the first periods included in the N-th synchronized signal, in the specific first period (it may be a singular or plural), the control unit 5 changes the frequency of the reduced clock signal to the frequency before the reduction.

This is as shown in FIG. 5. The clock frequency is reduced in the selecting period of the pseudo synchronization signal. However, the clock frequency is returned to the way it was before in the specific first period. According to the processing, in the first period when the clock frequency is returned, an original synchronization signal is generated by the generating unit 3. Since the pseudo synchronization signal generating unit 8 generates a pseudo synchronization signal using the generated synchronization signal after the present time, the generation timing of the pseudo synchronization signal is refreshed.

Here, the length of the period indicated by the N-th synchronized cycle may be adjusted according to the receiving state. For example, when the receiving state is good, the refresh interval of the pseudo synchronization signal may be long. On the other hand, when the receiving state is bad, it is necessary to make the refresh interval of the pseudo synchronization signal shorter. In other words, when the receiving state is good, the control unit 5 makes the value of the variable “N” for the N-th synchronized cycle larger. On the contrary, when the receiving state is bad, the control unit 5 will make the value of the variable “N” of the N-th synchronized cycle smaller.

When the length of the N-th synchronized cycle is long, the interval between the periods when the frequency of the supply clock signal is restored becomes longer, and the interval of refreshing the pseudo synchronization signal becomes longer. Although the power consumption is reduced all the more, since the receiving state is good, even if the pseudo synchronization signal, which is not refreshed, is used, there is hardly influence on the communication apparatus 1.

On the contrary, when the length of the N-th synchronized cycle is short, the refresh interval of the pseudo synchronization signal becomes shorter. Although the amount of reduction of power consumption decreases, since the pseudo synchronization signal is frequently refreshed, the reception quality of the communication apparatus 1 is maintained.

In addition, the control unit 5 may define the value of the variable “N”, according to the judgment result of the judging unit 12.

In addition, although the pseudo synchronization signal is generated according to the synchronization signal generated by the generating unit 3 and the synchronized cycle, once it starts being generated, it does not require the synchronization signal from the generating unit 3. For this reason, when the receiving state changes, the timing position of the pseudo synchronization signal and the original timing of the synchronization signal may be misfit. Refreshing the pseudo synchronization signal is generating the pseudo synchronization signal at the timing position that is close to the original timing position again, according to the original synchronization signal generated by the generating unit 3 and the synchronized cycle.

### Embodiment 3

Next, Embodiment 3 of the present invention will be explained.

In Embodiment 3 of the present invention, a semiconductor integrated circuit, which has the function explained in Embodiments 1 and 2, will be explained.

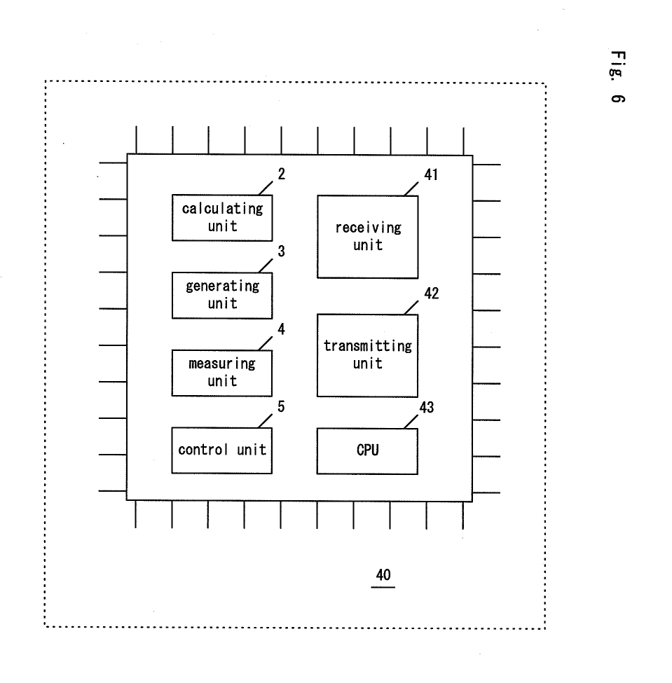

FIG. 6 a block diagram of a semiconductor integrated circuit according to the present invention.

A semiconductor integrated circuit 40 is provided with a block corresponding to the function explained in Embodiments 1 and 2, a receiving unit 41, a transmitting unit 42, and a CPU 43. In addition, the receiving unit 41 includes the element shown in FIG. 1, and not shown in FIG. 6.

The semiconductor integrated circuit 40 is built in an electronic device or a communication device, for example, a digital television, a mobile terminal, a cellular phone, a notebook personal computer, a car navigation system, and so on. Of course, it may be distributed by itself.

As explained in Embodiments 1 and 2, the calculating unit 2 calculates the correlation value of the predetermined pattern included in the receiving signal.

According to the correlation value, the generating unit 3 detects the border of the receiving signal, and generates the synchronization signal. After measuring the synchronized cycle, the measuring unit 4 defines the first period and the second period according to the synchronization signal.

The control unit 5 controls the power consumption by operating the electronic signal of at least one of the calculating unit 2 and the generating unit 3 in the second period. As specifically explained in Embodiments 1 and 2, the control unit 5 performs the reduction of the frequency of the supply clock signal.

Moreover, as explained in Embodiment 2, according to the pseudo synchronization signal, it is possible to realize both of the reduction of power consumption and the accuracy maintenance of reception processing.

As mentioned above, according to the semiconductor integrated circuit in Embodiment 3, it is possible to reduce the unnecessary power consumption while maintaining the reception quality.

### Embodiment 4

Next, Embodiment 4 will be explained.

In Embodiment 4, the electronic device included in the communication apparatus explained in Embodiments 1 and 2 will be explained.

The communication apparatus explained in Embodiments 1 and 2 is applied to various electronic devices as it is.

Here, as an example of the electronic device, all electronic devices having a function of performing communication are included. For example, they are a cellular phone, a mobile terminal, a notebook personal computer, a car-navigation system, and so on.

As explained in Embodiments 1 and 2, these electronic devices are provided with: the calculating unit 2 operable to calculate the correlation value of the receiving signal; the generating unit 3 operable to generate the synchronization signal; the measuring unit 4; and the demodulating unit 10. In the second period, the electronic signal of at least one of the calculating unit 2 and the generating unit 3 is operated.

The electronic device to be explained in Embodiment 4 is provided with: the communication apparatus 1 explained in Embodiments 1 and 2; and the semiconductor integrated circuit 40 explained in Embodiment 3. According to the communication apparatus 1 and the semiconductor integrated circuit 40, the electronic device can perform data communication by radio or a cable.

According to the function, in the communication function, which the electronic device has, it is possible to reduce the unnecessary power consumption, and is possible to reduce the power consumption of the electronic device without giving the influence on the accuracy of the communication function.

In addition, the receiving signal of the present invention may be anything as long as it is the signal method detecting the synchronized detection according to the correlation calculating, and is widely applied to the signal method, for example, a spread spectrum signal, an OFDM signal, and so on.

### INDUSTRIAL APPLICABILITY

The present invention can be preferably used, for example, in the field of a communication apparatus for receiving a receiving signal by wireless communication, or the like.

1. A communication apparatus comprising:
a calculating unit operable to calculate a correlation value of a predetermined pattern included in a receiving signal;
a generating unit operable to generate a synchronization signal based on the correlation value;
a measuring unit operable to measure a predetermined cycle based on the synchronization signal; and
a control unit operable to control power consumption of at least one of said calculating unit and said generating unit,
wherein: said measuring unit defines a first period possessing a predetermined length and a second period not overlapping with the first period, the first period includes the synchronization signal on time axis; and
said control unit operates an electric signal of at least one of said calculating unit and said generating unit in the second period, thereby controlling the power consumption.

2. A communication apparatus as defined in claim 1, wherein:
the electric signal includes a supply clock signal supplied for at least one of said calculating unit and said generating unit; and
said control unit reduces frequency of the supply clock signal in the second period, thereby controlling the power consumption.

3. A communication apparatus as defined in claim 1, wherein:
at least one of said calculating unit and said generating unit comprises a memory element;
the electric signal includes a held signal held by said memory element; and
said control unit causes the held signal possess a specific value in the second period, thereby controlling the power consumption.

4. A communication apparatus as defined in claim 1, wherein:
the electric signal includes an enable signal supplied for said memory element; and
said control unit keeps the enable signal in an ineffective status in the second period, thereby controlling power consumption.

5. A communication apparatus as defined in claim 3, wherein said memory element includes a flip flop circuit.

6. A communication apparatus as defined in claim 1, wherein said measuring unit adjusts the predetermined length of the first period based on the correlation value.

7. A communication apparatus as defined in claim 1, further comprising:
a cycle deviation calculating unit operable to calculate a cycle deviation of a synchronized cycle, the synchronized cycle being defined as a time interval between the synchronization signal and a synchronization signal adjacent to the synchronization signal on time axis,
wherein said measuring unit adjusts the predetermined length of the first period based on the cycle deviation.

8. A communication apparatus as defined in claim 1, further comprising:
a judging unit operable to judge signal quality of the receiving signal, thereby outputting a judgment result,
wherein said measuring unit adjusts the predetermined length of the first period based on the judgment result.

9. A communication apparatus as defined in claim 8, further comprising:
a demodulating unit operable to demodulate the receiving signal; and
an error detecting unit operable to detect an error based on output from said demodulating unit,
wherein said judging unit judges the signal quality based on a result outputted from said error detecting unit.

10. A communication apparatus as defined in claim 1, further comprising:
a pseudo synchronization signal generating unit operable to generate, based on the synchronization signal, a pseudo synchronization signal rising at every predetermined cycle; and
a selecting unit operable to select either the synchronization signal or the pseudo synchronization signal,
wherein said control unit operates an electric signal of at least one of said calculating unit and said generating unit in both of the first period and the second period, thereby controlling the power consumption when the pseudo synchronization is selected.

11. A communication apparatus as defined in claim 10, wherein:
the electric signal includes a supply clock signal supplied for at least one of said calculating unit and said generating unit; and
said control unit reduces frequency of the supply clock signal in both of the first period and the second period, thereby controlling the power consumption, when said selecting unit selects the pseudo synchronization signal.

12. A communication apparatus as defined in claim 11, wherein:
a synchronized cycle is defined as a time interval between synchronization signals adjacent to each other on time axis;
a plurality of first periods are included in an N (N is a natural number.) number of synchronized cycles, each of which being the synchronized cycle; and the plurality of first periods including a specific first period; and
said control unit returns the reduced frequency of the supply clock signal to former not reduced frequency in the specific first period among the plurality of first periods.

13. A communication apparatus as defined in claim 12, wherein said control unit operates the N number of the synchronized cycles based on a judgment result outputted from said judging unit.

14. A communication apparatus as defined in claim 10, wherein:
at least one of said calculating unit and said generating unit comprises a memory element;
the electric signal includes a held signal by said memory element; and
said control unit causes the held signal possess a specific value in both of the first period and the second period when said selecting unit selects the pseudo synchronization signal.

15. A communication apparatus as defined in claim 10, wherein said selecting unit selects the pseudo synchronization signal when said generating unit generates not less than a predetermined number of the synchronization signals.

16. A semiconductor integrated circuit comprising:
a calculating unit operable to calculate a correlation value of a predetermined pattern included in a receiving signal;
a generating unit operable to generate a synchronization signal based on the correlation value;
a measuring unit operable to measure a predetermined cycle based on the synchronization signal, and
a control unit operable to control power consumption of at least one of said calculating unit and said generating unit,
wherein: said measuring unit defines a first period possessing a predetermined length and a second period not overlapping with the first period, the first period includes the synchronization signal on time axis; and
said control unit operates an electric signal of at least one of said calculating unit and said generating unit in the second period, thereby controlling the power consumption.

17. A semiconductor integrated circuit as defined in claim 16, wherein
the electric signal includes a supply clock signal supplied for at least one of said calculating unit and said generating unit; and
said control unit reduces frequency of the supply clock signal in the second period, thereby controlling the power consumption.

18. An electronic device comprising:
a calculating unit operable to calculate a correlation value of a predetermined pattern included in a receiving signal;
a generating unit operable to generate a synchronization signal based on the correlation value;
a measuring unit operable to measure a predetermined cycle based on the synchronization signal, and
a control unit operable to control power consumption of at least one of said calculating unit and said generating unit,
wherein said measuring unit defines a first period possessing a predetermined length and a second period not overlapping with the first period, the first period includes the synchronization signal on time axis; and
said control unit operates an electric signal of at least one of said calculating unit and said generating unit in the second period, thereby controlling the power consumption.

19. A electronic device as defined in claim 18, wherein said electronic device is one of a mobile phone terminal, a mobile terminal, a notebook personal computer and a television set.
